(19) United States
(12) Patent Application Publication
(10) Pub. No.: US 2005/0042147 A1
(43) Pub. Date: Feb. 24, 2005

(54) Package containing a scented and custom treated card

(76) Inventors: Wendy Nan Rees, Los Angeles, CA (US); Thomas D. Rees, Los Angeles, CA (US)

Correspondence Address: W. Edward Johansen, 11661 San Vicente Boulevard, Los Angeles, CA, 90049, US

(21) Appl. No.: 10/645,205

(22) Filed: Aug. 21, 2003

(51) Int. Cl. B01D 46/00

(52) U.S. Cl. 422/124; 96/222; 96/223

(57) ABSTRACT

The invention is a pre-scented and custom treated card for use with a vacuum cleaner having an intake nozzle, a receptacle and a blower that creates a flow from the nozzle to the receptacle so as to carry dirt from the nozzle into the receptacle. The pre-scented and custom scented card includes a card and oil containing a fragrance, an anti-bacterial agent and/or an odor eliminator. The card is formed from a material that is capable of absorbing a fragrance. The oil containing the fragrance, the anti-bacterial eliminator and/or the odor eliminator are disposed on the card. The card may be cut into a plurality of strips that are then inserted into the receptacle through the opening of the bag or receptacle.

### BACKGROUND OF THE INVENTION

The present invention relates to vacuum cleaner bags, receptacles and filters and more particularly to a scented and custom treated card for being cut into strips for insertion into a vacuum cleaner bag, a receptacle or a filter.

U.S. Pat. No. 5,342,420 teaches a dust and dirt collecting apparatus for a vacuum cleaner that includes a porous bag defining a dust and a dirt collecting enclosure. A releasing strip is disposed on an outer surface of the bag. The releasing strip releases an active agent (such as a deodorant) into air passing through the vacuum cleaner. A covering associated with the releasing strip may be switched from a first condition blocking release of the active agent by the releasing strip to a second condition enabling release of the active agent by the releasing strip.

Replaceable vacuum cleaner bags and bag-less vacuums used removable filters. These filter can be cleaned, reused or replaced and optionally may add deodorant to the air passing through them. This allows the users of vacuum cleaners with filtered receptacles or disposable vacuum cleaner bags to add an active ingredient to the air that is filtered by their vacuum cleaners. The active ingredient is, broadly speaking, a deodorant. The term “deodorant” means true deodorants. These deodorants actually neutralize the offending smells. The re-odorants do not actually neutralize the offensive smells, but rather add more acceptable fragrances into the air to mask the offending smells] and disinfectants that through their antibacterial activities tend to eliminate the source of the offending smells. Actual specific odor eliminators, such as those that are developed for certain air freshener sprays and dispensers, the purpose of which would be to neutralize and thereby eliminate certain unpleasant or offensive odors may also be introduced and utilized. Disposable vacuum cleaner bags dispense active ingredients, such as deodorants into filtered effluents in the air passing through the vacuum cleaner. These bags have apparently encountered at least two difficulties. One difficulty is the requirement that the effective action of the active ingredients must be sustained over extended periods of time including store shelf storage prior to purchase and home storage prior to initial use. The other difficulty is the unacceptably high expenses involved in uniformly applying the requisite high saturation levels of expensive active ingredients. From a commercial point of view, while most prospective customers will be attracted by the capability of dispensing an active ingredient such as a deodorant into the air passing through the vacuum cleaner, there are those who, at least at one time or another, as a matter of preference or for health reasons, would prefer not to release the active ingredient into such air. Manufacturers of the bag or filter may make two different bags or filters—one that dispenses the active ingredient and another that does not. The economics of manufacturing two products versus one product and the competition for shelf space in the retail sales outlets suggest the advantages of a single product that either will or will not dispense the active ingredient into the air, as desired by the ultimate user. There is an extra expense that is involved in adding to air an active agent dispenser to each vacuum cleaner bag or receptacle at the point of manufacture. In spite of this it is still more economical and makes far better business sense to offer a single separate product which affords the ultimate user the option of adding the active ingredient or not, as he/she wishes to either a new or used vacuum bag. This is much than having to manufacture, ship, and stack two different products, one with the dispenser and one without. User would have to go to great lengths and would waste many bags if they had to switch a neutral bag out for a fragment bag.

U.S. Pat. No. 5,040,264 teaches a vacuum cleaner bag of porous material that includes a substrate impregnated with anti-static and deodorizing agents. The substrate may also be impregnated with disinfecting agents. Preferably, the substrate is attached to the bag. Vacuum cleaners that force air through a porous bag or through a bag-less receptacle that uses a filter that can be cleaned or replaced entirely and that forms a dust and dirt-collecting enclosure have long been known in the art. While such devices are particularly adapted for and effective in collecting even fine particles of dust and dirt, a vacuum cleaner equipped with a bag or a filter alone does little to freshen and deodorize the air that passes from the bag. In fact, the exhausted air may even pick up undesirable odors from dirt already in the bag. These odors are then transferred to the room being vacuumed. While this system does serve to provide some air freshening, it does suffer from several drawbacks. More specifically, the operator must remember to periodically add a new fragrance tablet to a scent-dispenser or otherwise the system is effectively rendered inoperative. Additionally, it should be appreciated that only some of the exhausted air is routed through the scent dispenser. The other portion remains untreated and is exhausted into the room. This system still serves to spread some odors from the vacuum bag into the room from this untreated air.

U.S. Pat. No. 5,461,751 teaches that cedar chips are used as an air freshener and pesticide in a vacuum cleaner bag. The chips can be loose or contained in a porous “tea bag.” Cedar oil may be used to augment the effect of the chips. The chips are placed in the receptacle or vacuumed from the floor. It should be noted, however, that in the case where additional oil is applied in liquid form, this liquid will stick to the inside of the vacuum tubes, receptacle, bags and/or filters thereby causing an accumulation of globules of dirt. Vacuum cleaner receptacles or bags typically hold more dirt than is vacuumed up at one time. Thus, the dirt and other contaminants sit in the receptacle while the vacuum cleaner is stored in a closet or other space. While stored, air in the receptacle is or becomes malodorous. Of necessity, the receptacle is porous, and the malodorous air contaminates the storage space. In addition, dust mites and other pests emanate from or are attracted by the dirt in the receptacle. When the vacuum is reactivated this potentially polluted pocket of air is blasted into the area where the vacuum is being used.

Accordingly, it is desirable to provide an air freshener and a pesticide for the receptacle. U.S. Pat. No. 4,554,698, U.S. Pat. No. 4,735,626, U.S. Pat. No. 5,029,359 and U.S. Pat. No. 5,040,264 show examples of air fresheners for vacuum cleaner receptacles.

Cedar has recently gained acceptance as a natural air freshener and moth repellant. For example, Cedar Fresh Products of Norristown, Pa. sells cedar sachets for clothing. The sachets are porous receptacles containing cedar, as described in an article from Home Furnishings Daily (December 1991) entitled “Cedar Fresh Wins EPA Ok.”

It would be desirable to utilize the characteristics of cedar as an air freshener and pesticide in a vacuum cleaner receptacle by utilizing a single effective delivery system.

### SUMMARY OF INVENTION

The present invention is generally directed to a vacuum cleaner that has an intake nozzle, a receptacle or bag, and a blower or other dirt lifting means for creating a flow from the nozzle to the receptacle so as to carry dirt from the nozzle into the receptacle.

In a first aspect of the present invention strips of a pre-scented and custom treated card are inserted into the receptacle.

In a second aspect of the present invention a vacuum-sealed, plastic package contains the pre-scented and custom treated card.

In a third aspect of the present invention before a user inserts the strips he may bend them so that they form an angle. This bent in the strips will help to guarantee airflow across a larger surface area of each of the strips because the strips will not be able to either lie against or stick to the side of the bag or filter thereby reducing the benefit of their scented qualities.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 shows a partially cut away perspective drawing of a vacuum cleaner according to U.S. Pat. No. 5,461,751.

FIG. 2 is a partially cut away perspective drawing of a sack containing cedar chips.

FIG. 3 is a perspective drawing of a vacuum cleaner that has a vacuum bag.

FIG. 4 is a perspective drawing of a vacuum-sealed, plastic package containing a pre-scented and custom treated card that is disposed inside the plastic package according to the present invention.

FIG. 5 is a perspective view of the vacuum-sealed, plastic package of FIG. 4 that has been opened at its bottom edge so that the pre-scented and custom treated card can be cut into a plurality of strips.

FIG. 6 is a cross-section of the vacuum-sealed, plastic package of FIG. 1 with two strips of the pre-scented and custom treated card of FIG. 4 each of the two strips having been bent.

### DESCRIPTION OF THE PREFERRED EMBODIMENT

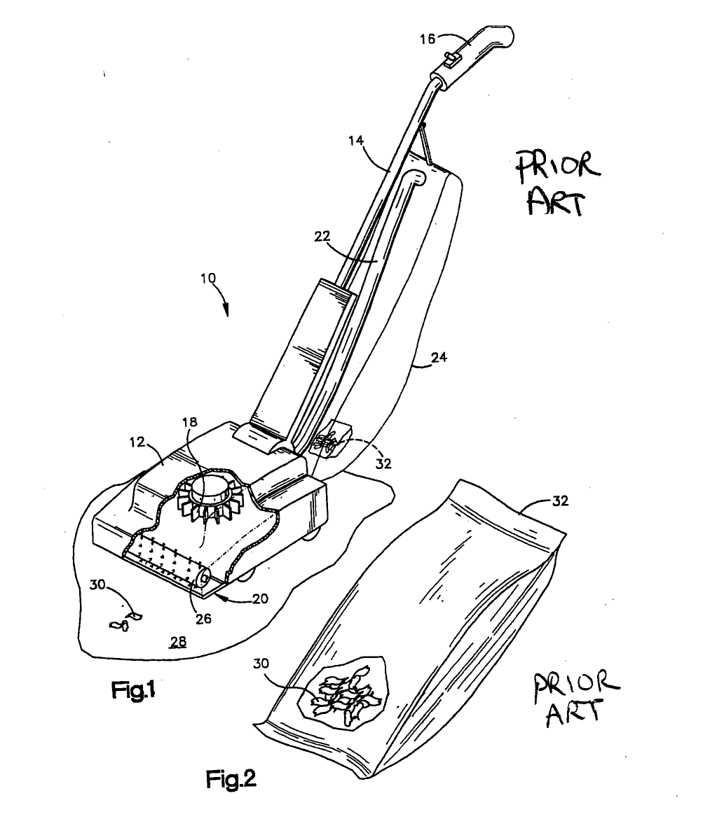

Referring to FIG. 1, a vacuum cleaner 10 of the prior art has a body 12 and a pivoting arm 14 with a handle 16. The vacuum cleaner, although shown as an upright type vacuum, is applicable to any type of vacuum having a receptacle or other device for collecting or containing dirt or other waste. A blower 18, fan, impeller or other vacuum-creating device of a type known in the art is disposed within the body. The blower 18 creates airflow from a downwardly opening intake nozzle 20, through the body 12 and a conduit 22, to a receptacle 24, bag, or other type of receptacle. The receptacle may be rigid or flexible. A rotating brush 26 or agitator is disposed in the nozzle 20 to loosen dirt on a floor 28 on which the vacuum is working. The blower, brush, or agitator, alone or in combination, defines a dirt lifting mechanism that propels the dirt from the floor into the bag or receptacle. The receptacle 24 is made of a porous material of a type known in the art so that air from the blower 18 flows through the receptacle while dirt entrained in the airflow is trapped in the receptacle. The receptacle is removable so that when the receptacle is full, it can be emptied or replaced. In use, cedar chips 30 are placed on the floor 28, preferably when a new receptacle 24 is installed on the vacuum cleaner 10. The cedar chips 30 are made of aromatic red cedar, similar to the type used for rodent bedding. The surface area of the chips should be maximized to provide the best results for the volume of chips used. Adding extract of cedar oil to the chips enhances the effect of the chips. The vacuum cleaner is run over the chips 30 to suck the chips into the receptacle 24. In the receptacle, the chips serve as an air freshener and pesticide. It should be noted that many vacuums also now use a reusable or replaceable filter, allowing air space inside the vacuum cleaner to act as a bucket or a receptacle that can be emptied by the user.

Alternatively referring to FIG. 2, the cedar chips are contained in a sack 32 similar to a tea bag. The sack is made from paper or another porous material suitable to hold the cedar chips while being permeable by air carrying vaporized cedar oil from the chips. The air passes through the sack 32 to freshen the air in the receptacle 24 and act as a pesticide. The size of the sack depends on the size of the receptacle 24. About one inch square has been found suitable for most applications. Prior to use, the cedar chips should be stored in an airtight container to preserve the effect of the oil. Separate cedar chips 30 or the sack 32 filled with chips can be placed directly in the receptacle when the receptacle 24 is removed or vacuumed into the receptacle 24 after the receptacle is installed.

Contemporary vacuum cleaners from a variety of manufacturers employ a variety of configurations of disposable filter paper vacuum cleaner bags with design configurations that will vary dependent on such factors as whether the vacuum cleaner employing the air-porous bag is an upright or canister style vacuum cleaner configuration, and, if an upright design, then whether the dust and dirt is top-filled into the bag or receptacle or is blown up into the bag or built-in receptacle. Air containing this dust and dirt is directed into the interior of the bag or receptacle through a tube that extends from the impeller of the vacuum cleaner. The pressure of the air injected into the bag from the tube is greater than atmospheric pressure, which causes the air in the bag's interior to escape as an effluent flow from the bag by passing through the porous filter material of the bag. The tube retains the by means of a restraining ring or other bag-positioning device. The pattern of pressures and rates of flow of air effluent from the bag will be contingent on a variety of factors, including: the amount of dirt retained in the bag or receptacle; the airflow impedances or resistance imposed by the shape and size of the chamber of container in which the bag is retained or the receptacle is designed. The design of the vacuum cleaner; the degree of coarseness and fibrous content of the dirt and other materials within the dust and dirt collecting enclosure inside the bag or receptacle after it has been in use; the weight, thickness, and porosity of the filter paper material; and the pattern of construction of the bag or filter itself.

Referring to FIG. 1 a vacuum cleaner 110 includes a dust and dirt collecting apparatus 112 that includes a porous bag defining a dust and dirt collecting enclosure 114. The bag 112 is a disposable paper filter vacuum cleaner bag or receptacle of one of the configurations described above, the bag 112 further defining the dust and dirt collecting enclosure 114 there-within, an outer surface 116 there-without and an air inlet 118 leading into the enclosure 114. A stiffener 119, such as cardboard, may be secured to bag 112 about the air inlet 118 to facilitate operative connection of the bag air inlet 118 to the vacuum cleaner 110.

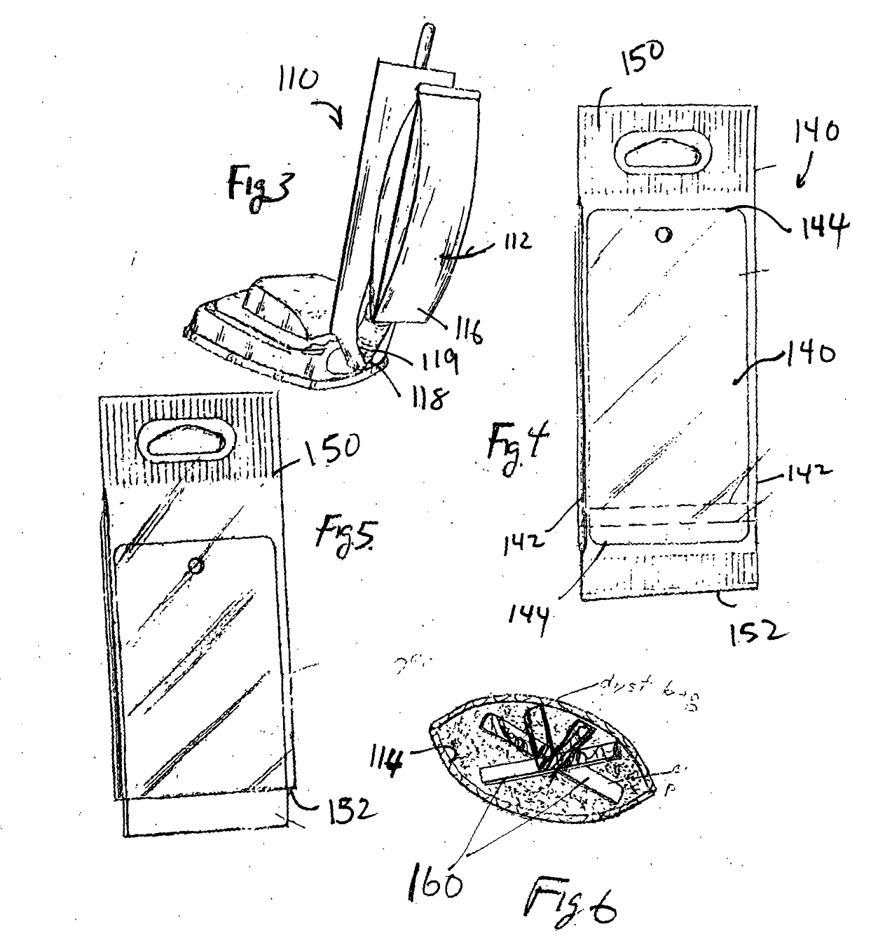

Referring to FIG. 4 the card 140 is capable of absorbing a fragrance. The card 140 may be made from different grades of blotting paper. The card 140 may also be made from a non-woven, porous materials or a synthetic carrier materials, such as either extruded polyethylene or molded polystyrene based materials that will hold fragrance and allow evaporative emittance of the fragrance. These materials include TYVEK sheeting (available from E. I. duPont de Nemours & Co.), TESLIN, micro-porous sheeting (available from PPG Industries, Inc. of Pittsburgh, Pa.), POREX, porous plastic sheeting (available from Porex Technologies Corp. of Fairburn, Ga.), CELWA paper pads, (available from John H. Willig, who is doing business as Celwa Products Co. of New York, N.Y.). The card 140 has a first pair of opposed-sides 142 and a second pair of opposed-sides 144. If the card 140 is square, the sides 142 and 144 are of the same length. On the other hand, if the card is rectangular, the sides 22 are long sides and the sides 144 are short sides. Although shown as a rectangle, the insert can be die-cut shape to a desired shape, or have die-cut perorations so that the insert can be punched out from a blank in a desired shape.

The card 140 may be printed with graphics. The graphics can be ornamental or provide instructions for use of the cards. Such graphics can be printed on the card 140. One method for printing graphics is by sheet fed litho-graphic offset. The insert can be provided as either scented or unscented. If provided as an unscented insert, the consumer can apply his or her own fragrance to the insert by either spraying the insert or dipping the insert in a desired fragrance (i.e., a perfume, cologne, etc.) If the insert is pre-scented, the fragrance can be applied either by roller or spray application. The fragrance formulation preferably comprises fragrance oil and a DPG diluent.

The fragrance load is approximately 2.0 grams per toilet tissue insert and 4.0 grams for paper towel inserts. The fragrance applied can consist of micro-encapsulated-fragrance oil. This extends the shelf life of the scented insert and provides a refreshing feature to the insert. The evaporation of the fragrance from the insert can be either enhanced or retarded. Applying a second film of either a plasticizing agent or ink retards evaporation after the fragrance has been applied to the insert. Polymers, such as dipropyleneglycol (DPG), diethylphthylate (DEP) or similar solvents, can also be added to the fragrance formulation to thicken the fragrance coating to achieve a heavier coating weight. This will also retard the rate of evaporation of the fragrance from the insert. Evaporation enhancers, such as denatured alcohol (39C), can be added to the fragrance formulation to increase the rate of evaporation of the fragrance from the insert. The cards 20 are formed as individual cards. The cards 140 are packaged in a package 150. The plastic package 150 is a four-sided, sealed PVDC coated polyester or cellophane pouch with a hanger hole 151 for peg rack display. A paper or cardboard backing may allow the cellophane pouch to be stapled to the paper or cardboard backing. The paper of cardboard backing has a logo and directions for use that are printed thereon.

Referring to FIG. 5 in conjunction with FIG. 4 the package 150 is to be opened at its bottom edge 152 so that the pre-scented and custom scented card 140 can be cut into a plurality of strips 160.

Referring to FIG. 6 in conjunction with FIG. 1 two strips 160 of the pre-scented and custom scented card 140 are disposed in the bag 112.

From the foregoing it can be seen that a pre-scented and custom treated card is disposed in a sealed plastic package that when opened allows a plurality of strips to be cutting from the pre-scented and custom treated card has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

1. For use with a vacuum cleaner having an intake nozzle, a receptacle and a blower that creates a flow from the nozzle to the receptacle so as to carry dirt from the nozzle into the receptacle, a pre-scented and custom treated card comprising:
a. a card formed from a material that is capable of absorbing a fragrance; and
b. oil containing at least one of a fragrance, an anti-bacterial agent and an odor eliminator disposed on said card so that said card may be cut into a plurality of strips which can then be bent at their centers so said strips do not to stick to the side of the receptacle, thereby potentially increasing airflow across the surface area of said strips when said strips are inserted into the receptacle through the opening of the receptacle.
